(19) United States
(12) Patent Application Publication
(10) Pub. No.: US 2026/0217147 A1
(43) Pub. Date: Jul. 30, 2026

(54) ROBOT AND CONTROL METHOD THEREFOR, AND METHOD FOR CONTROLLING ROBOT CHARGING SYSTEM INCLUDING STATION DEVICE AND ROBOT

(71) Applicant: SAMSUNG ELECTRONICS CO., LTD., Suwon-si (KR)

(72) Inventors: Jinchul SHIN, Suwon-si (KR); Geunpil PARK, Suwon-si (KR); Heyunmoon BANG, Suwon-si (KR); Jungjae LEE, Suwon-si (KR)

(73) Assignee: SAMSUNG ELECTRONICS CO., LTD., Suwon-si (KR)

(21) Appl. No.: 19/573,567

(22) Filed: Mar. 20, 2026

Related U.S. Application Data
(63) Continuation of application No. PCT/KR2024/017312, filed on Nov. 5, 2024.

(30) Foreign Application Priority Data
Nov. 7, 2023 (KR) 10-2023-0152871
Feb. 14, 2024 (KR) 10-2024-0020826

(51) Int. Cl. B60L 53/36; B60L 53/66; G01D 5/14; G05D 1/661; H02J 7/70; H02J 7/90; G05D 105/10

(52) U.S. Cl. CPC B60L 53/36; B60L 53/66; G01D 5/142; G05D 1/661; H02J 7/70; H02J 7/971; B60L 2240/70; G05D 2105/10

(57) ABSTRACT

A robot includes a communication interface, an electromagnet, a battery, memory storing instructions, and one or more processors. The instructions, executed by the one or more processors individually or collectively, cause the robot to control the communication interface to communicate with the station device based on an event for charging the battery, receive information about a docking status from the station device through the communication interface based on the robot being docked with the station device, apply current to the electromagnet to generate the magnetic field based on the information about the docking status, and charge the battery by receiving power from the station device based on the magnetic field being detected by the Hall sensor.

### CROSS-REFERENCE TO RELATED APPLICATIONS

This application is a bypass continuation application of International Patent Application No. PCT/KR2024/017312, filed on November 5, 2024, which claims priority to and is based on Korean Patent Application No.10-2023-0152871, filed on November 7, 2023, and Korean Patent Application No. 10-2024-0020826, filed on February 14, 2024, the disclosures of which are incorporated herein in their entireties by reference.

### BACKGROUND

### 1. Field

Embodiments of the present disclosure relate to a robot and a control method therefor, and a method for controlling a robot charging system including a station device and a robot, and more particularly, to a robot capable of being docked with a station device to charge a battery of the robot through a charging unit of the station device, and a control method therefor, and a method for controlling a robot charging system including a station device and a robot.

### 2. Description of Related Art

Robots (e.g., cleaning robots) may be docked with a station device and charge batteries of the robots through a charging unit of the station device.

When the robot is docked with the station device, a Hall sensor included in the station device may recognize a magnetic field of a permanent magnet mounted on the robot, thereby detecting the docking of the robot. However, when the robot is in normal traveling mode in which the robot is not docked with the station device, the magnetic force of the permanent magnet mounted on the robot may cause a problem in which metallic foreign matter is attached to the permanent magnet. When the metallic foreign matter is attached to the permanent magnet and the station device supplies a current to the robot to charge the robot’s battery, a fire hazard may occur due to the metallic foreign matter.

### SUMMARY

According to an aspect of one or more embodiments of the present disclosure, a robot may include a communication interface configured to communicate with an external device; an electromagnet configured to generate a magnetic field in a Hall sensor included in a station device; a battery; memory storing instructions; and one or more processors connected to the communication interface, the electromagnet, the battery, and the memory. The instructions, when executed by the one or more processors individually or collectively, may cause the robot to: control the communication interface to communicate with the station device based on an event for charging the battery; receive information about a docking status from the station device through the communication interface based on the robot being docked with the station device; apply current to the electromagnet to generate the magnetic field based on the information about the docking status; and charge the battery by receiving power from the station device based on the magnetic field being detected by the Hall sensor.

The event for charging the battery includes at least one of: an event in which remaining battery of the robot falls below a threshold; an event in which a user command for returning to the station device is input; or an event in which the robot completes an operation corresponding to the user command.

The instructions, when executed by the one or more processors individually or collectively, may further cause the robot to, when the event for charging the battery occurs, return to the station device based on a map stored in the memory, and control the communication interface to communicate with the station device while returning to the station device.

The robot may further include an image sensor. The instructions, when executed by the one or more processors individually or collectively, may further cause the robot to, when the station device is recognized based on an image acquired through the image sensor, switch a mode of the robot from a normal traveling mode to a docking mode such that the robot is to be docked with the station device.

The station device comprises a switch. The instructions, when executed by the one or more processors individually or collectively, may further cause the robot to, based on the robot being docked with the station device, turn on the switch and receive information about the docking status from the station device through the communication interface.

The instructions, when executed by the one or more processors individually or collectively, may further cause the robot to, based on the robot receiving the information about the docking status through the communication interface, the switch being turned on, and a magnetic field being detected by the Hall sensor, apply a charging current to the battery of the robot.

Wherein the electromagnet is at a location corresponding to the Hall sensor of the station device based on the robot being docked with the station device.

According to an aspect of one or more embodiments of the present disclosure, a method for controlling a robot may include communicate with a station device based on an event for charging a battery; receiving information about a docking status from the station device based on the robot being docked with the station device; applying a current to an electromagnet included in the robot to generate a magnetic field based on the information about the docking status; and charging the battery by being supplied power from the station device based on the magnetic field being detected by a Hall sensor.

The event for charging the battery may be at least one of an event in which remaining battery of the robot falls below a threshold; an event in which a user command for returning to the station device is input; and an event in which the robot completes an operation based on the user command.

When the event for charging the battery occurs during the communication with the station device, the robot may return to the station device based on a map stored in the memory, and communicates with the station device while returning to the station device.

The receiving of the information may include switching a mode of the robot from a normal traveling mode to a docking mode so that the robot is docked with the station device, when the station device is recognized based on an image acquired through an image sensor of the robot.

The station device may include a switch. When the robot is docked with the station device during receipt of the information, the switch may be turned on to receive the information about the docking status through a communication interface.

When the robot receives the information about the docking status through the communication interface, the switch may be turned on, a magnetic field may be detected by the Hall sensor, and a charging current may be applied to the battery of the robot.

The electromagnet may be at a location corresponding to the Hall sensor of the station device based on the robot being docked with the station device.

According to an aspect of one or more embodiments of the present disclosure, a method for controlling a robot charging system including a station device and a robot may include establishing a connection between the robot and the station device while the robot is traveling toward the station device based on an event for charging a battery; turning on a switch included in the station device to transmit information about a docking status to the robot, based on the robot being docked with the station device; applying, by the robot, a current to an electromagnet included in the robot to generate a magnetic field based on the information about the docking status; supplying power based on the magnetic field being detected by a Hall sensor included in the station device; and charging, by the robot, the battery of the robot using the power supplied to the robot.

### BRIEF DESCRIPTION OF DRAWINGS

The above and other aspects, features, and advantages of one or more embodiments of the present disclosure will be more apparent from the following description taken in conjunction with the accompanying drawings, in which:

FIG. 1 is a diagram illustrating a robot charging system according to one or more embodiments of the present disclosure;

FIG. 2 is a block diagram illustrating a configuration of a robot according to an embodiment of the present disclosure;

FIG. 3 is a block diagram illustrating a configuration of a station device according to an embodiment of the present disclosure;

FIG. 4 is a flowchart for explaining a method for charging a battery by a robot docked with a station device according to an embodiment of the present disclosure;

FIG. 5 is a flowchart illustrating a specific method for charging a battery of a robot through the station device according to an embodiment of the present disclosure;

FIG. 6 is a diagram illustrating the robot docked with the station device according to an embodiment of the present disclosure; and

FIG. 7 is a flowchart for describing a method for controlling a robot charging system according to an embodiment of the present disclosure;

### DETAILED DESCRIPTION

Various embodiments of the present disclosure and terms used herein are not intended to limit the technical features described in the present disclosure to specific embodiments, and should be understood to include various changes, equivalents, or substitutes of the embodiments.

Throughout the accompanying drawings, similar or related components will be denoted by similar reference numerals.

A singular form of a noun corresponding to an item may include one or more of the item, unless the relevant context clearly dictates otherwise.

In the present disclosure, each phrase such as “A or B,” “at least one of A and B,” “at least one of A or B,” “A, B, or C,” “at least one of A, B and C,” and “at least one of A, B, or C” may include any one of items listed together in the corresponding one of those phrases, or all possible combinations thereof. For example, “A or B”, “at least one of A and B”, or “at least one of A or B” may indicate all of 1) a case in which at least one A is included, 2) a case in which at least one B is included, or 3) a case in which both of at least one A and at least one B are included.

The terms “first,” “second,” “third,” and the like in the description and in the claims, if any, are used for distinguishing between similar elements and not necessarily for describing a sequential or chronological order. It is to be understood that the terms so used are interchangeable under appropriate circumstances.

When one (e.g., first) component is “coupled,” or “connected,” to another (e.g., second) component with or without the terms “functionally” or “communicatively,” it means that the one component may be connected to another component directly (e.g., in a wired manner), in a wireless manner, or through a third component.

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features.

When a component is said to be “connected,” “coupled,” “supported,” or “in contact” with another component, this includes not only cases where the components are directly connected, coupled, supported, or in contact, but also cases where they are indirectly connected, coupled, supported, or in contact through a third component.

When a component is “on” another component, this includes not only cases where a component is in contact with another component, but also cases where there is another component between the two components.

A term ‘and/or’ includes a combination of a plurality of related described components or any one of the plurality of related described components.

Further, unless stated otherwise or otherwise clear from context, phrase “based on” may refer to “based at least in part on” and not “based solely on.”

An expression “~an apparatus configured to” may mean that the apparatus “is capable of” together with other apparatuses or components. For example, a “processor configured (or set) to perform A, B, and C” may mean a dedicated processor (for example, an embedded processor) for performing the corresponding operations or a generic-purpose processor (for example, a central processing unit (CPU) or an application processor) that may perform the corresponding operations by executing one or more software programs stored in a memory device.

Unless explicitly described or implicitly understood from one or more embodiments of the present disclosure, at least one of the components, elements, modules, units, or nominalized verbs represented by a block or equivalent indication in the drawings may be implemented or embodied by analog and/or digital circuits. These circuits may include one or more of a logic gate, an integrated circuit, a microprocessor, a microcontroller, a memory circuit, a passive electronic component, an active electronic component, an optical component, and the like. Alternatively or additionally, these components may be implemented or embodied by software including one or more instructions stored in an internal or external storage medium that is readable by at least one processor. For example, the at least one processor may invoke at least one of the one or more instructions stored in the storage medium and execute it, with or without using one or more other components under the control of the at least one processor. This allows the at least one processor to perform at least one function or operation described above as being performed by each of the components according to the at least one instruction invoked. The at least one processor may include a central processing unit (CPU), a graphics processing unit (GPU), or another type of microprocessor, without limitation. In other examples, the at least one processor may be implemented as an application-specific integrated circuit (ASIC) or field-programmable gate array (FPGA).

Various elements and regions in the drawings are schematically illustrated. Therefore, the spirit of the disclosure is not limited by relatively sizes or intervals illustrated in the accompanying drawings.

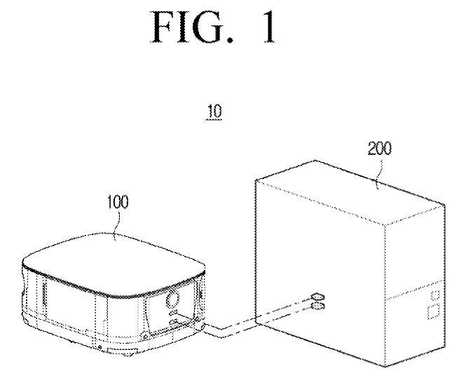

FIG. 1 is a diagram illustrating a robot charging system according to an embodiment of the present disclosure. As illustrated in FIG. 1, a robot charging system 10 includes a robot 100 and a station device 200. In this case, while the robot 100 may be a cleaning robot that moves around a cleaning space and cleans a floor of the cleaning space, this is merely an example and may be implemented as various robot devices, such as a serving robot or a guide robot. The station device 200 includes a charging unit capable of charging a battery of the robot 100. The station device 200 may be referred to by various terms, such as a charging station or a charging device.

In particular, the robot 100 may travel a specific space (e.g., home, office, restaurant, airport, etc.) and perform a preset function within a specific space. For example, when the robot 100 is a cleaning robot, the robot 100 is capable of cleaning the floor inside a home while moving throughout the home. As another example, when the robot 100 is a serving robot, the robot 100 may serve food while moving within a restaurant.

The robot 100 may include a battery, and use electrical energy stored in the battery to perform a preset function while moving within a specific space. While the robot 100 moves within a specific space and performs the preset function, the electrical energy of the battery is consumed, and an output voltage of the battery may decrease.

When the output voltage of the battery is higher than or equal to a preset minimum voltage, the robot 100 may operate normally. When the output voltage of the battery falls below the preset minimum voltage, the robot 100 may stop operation. Therefore, when the output voltage approaches the minimum voltage, the robot 100 may move to the station device 200.

The station device 100 may convert AC power received from an external power supply (e.g., a household AC power supply) into DC power and supply the DC power to the robot 100, thereby charging the battery of the robot 100.

The station device 200 is fixed to a predetermined location (e.g., a location designated by a user) and does not move unless there are special circumstances (e.g., when moved by a user). Since the station device 200 is located at a predetermined location, when the output voltage of the battery approaches the minimum voltage while moving through a specific space, the robot 100 may move toward the station device 200 to charge the battery based on the location information of the station device 200 included in a pre-stored map. Furthermore, the robot 100 may be docked with the station device 200 to charge the battery.

In particular, since the direct current provided by the station device 200 may have a fatal impact on humans, the station device 200 may perform a charging operation on the battery of the robot 100 after detecting that the robot 100 is docked with the station device 200.

In particular, according to an embodiment of the present disclosure, the robot 100 may include an electromagnet. In particular, the robot 100 may apply a current to the electromagnet upon detecting that the robot 100 is docked with the station device 200. The station device 200 may start a charging operation when the magnetic field of the electromagnet is detected by a Hall sensor.

Therefore, by applying a current to the electromagnet of the robot 100 only when the robot 100 is docked with the station device 200, the problem of metallic foreign matter attaching to the permanent magnet due to the magnetic force of the magnet provided in the robot during normal traveling mode may be resolved. Therefore, the risk of fire that may occur during charging may be reduced.

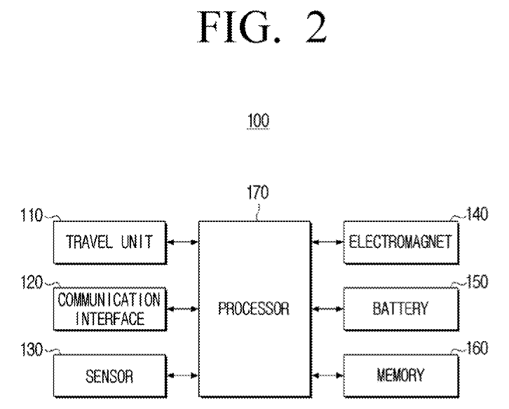

FIG. 2 is a block diagram illustrating a configuration of a robot according to an embodiment of the present disclosure. As illustrated in FIG. 2, the robot 100 may include a travel unit 110, a communication interface 120, a sensor 130, an electromagnet 140, a battery 150, memory 160, and a processor 170. It should be noted that the configuration illustrated in FIG. 2 is merely an example, and various components may be added or deleted depending on the type of robot 100.

The travel unit 110 may move the robot 100. For example, the travel unit 110 may include at least one wheel, at least one motor for rotating the wheel, a brake for stopping the rotating wheel, etc. The processor 170 may control the travel unit 110 to perform various traveling operations, such as movement, stopping, speed control, direction change, and angular velocity change, of the robot 100.

In particular, the travel unit 110 may travel in one of a normal traveling mode and a docking mode. In this case, the normal traveling mode is a mode in which the robot 100 travels while moving around a specific space and performing preset functions (e.g., cleaning, serving, etc.), and the docking mode is a mode in which the robot travels to be docked with the station device 100. In this case, the travel unit 100 may operate at different speeds depending on the mode.

Furthermore, when a battery charging event is detected, the travel unit 110 may travel to the station device 200.

The communication interface 120 may communicate with an external device via a network. The external device may include a server, a station device 200, home appliances, mobile devices (e.g., smartphones, tablet PCs, wearable devices, etc.). The communication interface 120 may include a wireless communication module or a wired communication module. The communication module may be implemented with at least one hardware chip.

The network may include a wide area network (WAN) such as the Internet, a local area network (LAN) formed around an access point (AP), and a short-range wireless network that does not utilize the access point (AP). The short-range wireless network may include, but are not limited to, Bluetooth™ (IEEE 802.15.1), Zigbee (IEEE 802.15.4), Wi-Fi Direct, near field communication (NFC), Z-Wave, etc.

In one example, the communication interface 120 may communicate with the external device via the access point (AP). For example, the access point (AP) may connect the local area network (LAN) to which the robot 100 is connected to the wide area network (WAN) to which the server is connected. The robot 100 may be connected to the server via the WAN. The access point (AP) may communicate with the robot 100 using wireless communication such as Wi-Fi (Wi-Fi™, IEEE 802.11), Bluetooth, or Zigbee, and may connect to the WAN using wired communication. In addition, the communication interface 120 may communicate with other external devices via the server. For example, the communication interface 120 may communicate with home appliances, mobile devices, etc., via the server.

According to one example, the robot 100 may be directly connected to the external device without going through the access point (AP). For example, the communication interface 120 may communicate with the external device via a long-range wireless network or a short-range wireless network. The robot 100 may be connected to home appliances, mobile devices, etc., via the short-range wireless network (e.g., Bluetooth, Wi-Fi Direct). Furthermore, the robot 100 may be connected to the external devices via the WAN using the long-range wireless network (e.g., a cellular communication module).

The communication interface 120 may perform the communication connection with the communication interface of the station device 200 while the robot 100 is moving to be docked with the station device 200. When the robot 100 is docked with the station device 200, the communication interface 120 may receive, from the station device 200, information (e.g., information about successful docking) about the docking status. In this case, the communication interface 120 may communicate with the station device 200 using a Bluetooth module.

The sensor 130 may detect structures or objects in a specific space. The objects may include walls and obstacles within an indoor space. The obstacles may include various objects present in a specific space, such as furniture, home appliances, remote controls, keys, people, and pets. Furthermore, information acquired by the sensor 130 may be used to generate a map of the indoor space.

The sensor 130 may include an image sensor, a light detection and ranging (LiDAR) sensor, an obstacle detection sensor, and a traveling detection sensor.

The image sensor (or camera) may capture images of the surroundings of the robot 100 to generate the images. For example, the image sensor may capture the front of the robot 100.

According to one example, the image sensor may include a 3D image sensor (e.g., a depth camera). The 3D image sensor may capture the surroundings of the robot 100 to generate 3D spatial information related to the surroundings of the robot 100. For example, the 3D image sensor may detect the distance to an object around a robot 100 to generate an image (e.g., a depth image) including 3D distance information. The image may include depth information for each pixel. Accordingly, data acquired by the 3D image sensor may include 3D coordinate information (e.g., (x, y, z) coordinate values) of points searched by the 3D image sensor through scanning. For example, the 3D image sensor may be implemented in various ways, such as a stereo vision method, an infra red (IR) method, and a time of flight (TOF) method.

The LiDAR sensor outputs a laser beam in a 360° direction. When the laser beam reflected from the objects is received, the LiDAR sensor analyzes the time difference taken for the laser beam to be reflected from the objects and return, and the received laser beam signal intensity etc., thereby acquiring the geometry information about the indoor space. The geometry information may include the location, distance, direction, etc., of the object. The LiDAR sensor may provide the acquired geometry information to the processor 170.

The obstacle detection sensor may detect obstacles around the robot 100. For example, the obstacle detection sensor may include at least one of an ultrasonic sensor, an infrared sensor, a radio frequency (RF) sensor, a geomagnetic sensor, and a position sensitive device (PSD) sensor. The obstacle detection sensor may detect obstacles present in front, behind, to the side, or along the movement path of the robot 100. The obstacle detection sensor may provide detected obstacle information to the processor 170.

The traveling detection sensor may detect the traveling of the robot 100. For example, the traveling detection sensor may include at least one of a gyro sensor, a wheel encoder, and an acceleration sensor. The gyro sensor may detect the rotation direction and rotation angle of the robot 100. The wheel encoder may detect the number of rotations of the wheels of the robot 100. The acceleration sensor may detect the change in speed of the robot 100. The traveling detection sensor may provide the detected traveling information to the processor 170.

The electromagnet 140 is configured for the station device 200 to detect the docking of the robot 100. When the information about the docking status is received from the station device 200, a current may be applied to the electromagnet 140 to generate a magnetic field. During the normal traveling mode, a current may not be applied to the electromagnet 140, so a magnetic field may not be generated.

In particular, the electromagnet 140 may be disposed at a location corresponding to the Hall sensor 220 of the station device 200 when the robot 100 is docked with the station device 200.

The battery 150 may store electrical energy for the robot 100 to move and perform a preset function.

The battery 150 may convert electrical energy into chemical energy and store the chemical energy. In some examples, the battery 150 may be charged. Furthermore, the battery 150 may convert the chemical energy into the electrical energy and output the electrical energy (voltage and current). In some examples, the battery 150 may be discharged.

For example, when the voltage applied to the battery 150 by the external circuit is higher than the output voltage of the battery 150, the battery 150 may be charged, and when the voltage applied to the battery 150 by the external circuit is lower than the output voltage of the battery 150, the battery 150 may be discharged.

The battery 150 may supply electrical energy to electrical components included in the robot 100. In some examples, the battery 150 may apply a voltage and current to the travel unit 110, the communication interface 120, the sensor 130, the electromagnet 140, the memory 160, and the processor 170.

In addition, the battery 150 may further include a charging circuit, and the charging circuit may charge the battery 150 with power supplied from the station device 200.

The memory 160 may store data for the operation of the robot 100 according to various embodiments of the present disclosure. For example, the memory 160 may store a map of a specific space where the robot 100 is located.

The memory 160 may store one or more instructions. In addition, the memory 160 may store programs, applications, and data for driving the robot 100.

The processor 140 generally controls the operation of the robot 100. For example, the processor 170 may be connected to components of the robot 100 to control the overall operation of the robot 100. For example, the processor 170 may be connected to the travel unit 110, the communication interface 120, the sensor 130, the electromagnet 140, the battery 150, and the memory 160 to control the robot 100. The processor 170 may be composed of one or a plurality of processors.

The processor 170 may perform an operation of the robot 100 according to an embodiment of the present disclosure by executing at least one instruction stored in the memory 160.

The processor 170 may include one or more of a central processing unit (CPU), a graphics processing unit (GPU), an accelerated processing unit (APU), a many integrated core (MIC), a digital signal processor (DSP), a neural processing unit (NPU), a hardware accelerator, field programmable gate array (FPGA), application specific integrated circuit (ASIC), or a machine learning accelerator. The processor 170 may control one or any combination of other components of the robot 100 and may perform operations related to communication or data processing. The processor 170 may execute one or more programs or instructions stored in the memory 160. For example, the processor 170 may perform a method according to an embodiment of the present disclosure by executing one or more instructions stored in the memory 160. In some examples, processor 170 may execute the one or more instructions stored in the memory 160 to cause the various components (e.g., travel unit 110, communication interface 120, sensor 130, electromagnet 140, battery 150) of the robot 100 to perform operations described herein.

When the method according to an embodiment of the present disclosure includes multiple operations, the multiple operations may be performed by one processor or by multiple processors. For example, when a first operation, a second operation, and a third operation are performed by the method according to an embodiment, the first operation, the second operation, and the third operation may all be performed by the first processor, or the first operation and the second operation may be performed by the first processor (e.g., a general-purpose processor) and the third operation may be performed by the second processor (e.g., an AI-dedicated processor).

The processor 170 may be implemented as a single core processor including one core, or may be implemented as one or more multicore processors including multiple cores (e.g., a homogeneous multicore or a heterogeneous multicore). When the processor 170 is implemented as a multi-core processor, each of the plurality of cores included in the multi-core processor may include an internal processor memory such as cache memory and on-chip memory, and a common cache shared by the plurality of cores may be included in the multi-core processor. In addition, each of the plurality of cores (or some of the plurality of cores) included in the multi-core processor may independently read and execute a program command for implementing the method according to an embodiment of the present disclosure, or all (or some) of the plurality of cores may be linked to read and execute the program command for implementing the method according to an embodiment of the present disclosure.

When the method according to an embodiment of the present disclosure includes a plurality of operations, the plurality of operations may be performed by one of the plurality of cores included in the multi-core processor, or may be performed by the plurality of cores. For example, when the first operation, the second operation, and the third operation are performed by the method according to one embodiment, the first operation, the second operation, and the third operation may all be performed by a first core included in the multi-core processor, or the first operation and the second operation may be performed by the first core included in the multi-core processor, and the third operation may be performed by a second core included in the multi-core processor.

In the embodiments of the present disclosure, a processor may mean a system on chip (SoC) in which one or more processors and other electronic components are integrated, a single core processor, a multi-core processor, or a core included in the single core processor or the multi-core processor. Here, the core may be implemented as the CPU, the GPU, the APU, the MIC, the DSP, the NPU, the hardware accelerator, the machine learning accelerator, etc., but the embodiments of the present disclosure are not limited thereto.

According to an embodiment of the present disclosure, when an event for charging a battery occurs, the processor 170 controls the communication interface 120 to perform the communication connection with the station device 200. When docked with the station device 200, the processor 170 receives the information about the docking status from the station device 200 via the communication interface 120. Based on the information about the docking status, the processor 170 applies a current to an electromagnet to generate a magnetic field. In this case, when the magnetic field is detected by the Hall sensor 220 of the station device 200, power is supplied from the station device 200 to charge the battery 150.

According to an embodiment of the present disclosure, the event for charging the battery may be one of an event in which the battery charge of state (e.g., remaining battery) of the robot 100 falls below a threshold, an event in which a user command for returning to the station device 200 is input, and an event in which the robot 100 completes an operation corresponding to the user command.

According to an embodiment of the present disclosure, when an event for charging the battery 150 occurs, the processor 170 may control the travel unit 110 to return to the station device 200 based on the map stored in the memory 160. The processor 170 may control the communication interface 120 to perform the communication connection with the station device 200 while returning to the station device 200.

According to an embodiment of the present disclosure, when the station device 200 is recognized based on an image acquired through an image sensor, the processor 170 may control the travel unit 110 to switch the mode of the robot 100 from the normal traveling mode to the docking mode and be docked with the station device 200.

According to an embodiment of the present disclosure, when the robot 100 is docked with a station device 200, the processor 170 may receive information about whether the robot is docked with the station device 200 through the communication interface 120 by turning on the switch included in the station device 200.

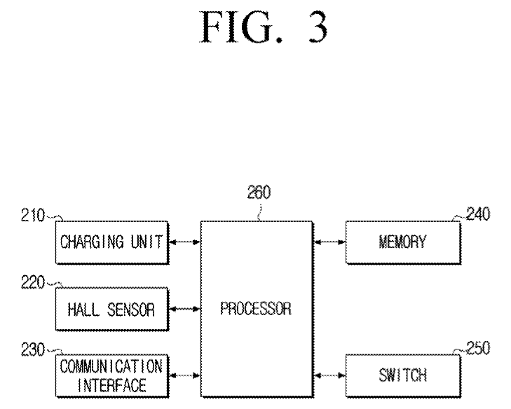

FIG. 3 is a block diagram illustrating a configuration of a station device according to an embodiment of the present disclosure. As illustrated in FIG. 3, the station device 200 includes a charging unit 210, a Hall sensor 220, a communication interface 230, a memory 240, a switch 250, and a processor 260.

The charging unit 210 converts AC power from an external power supply (PS) into DC power for charging the battery 150 of the robot 100 and supplies the DC power to the robot 100.

The charging unit 210 may include a rectifier, a DC-DC converter, and a charging terminal. The rectifier may receive AC power from the external power source (PS), convert the AC power of the external power supply (PS) into DC power, and output the converted DC power. For example, the rectifier may include a bridge diode that converts the direction of AC voltage and AC current into a positive voltage and positive current, and a capacitor that eliminates fluctuations in the positive voltage.

The DC-DC converter may change the voltage value of the DC power rectified by the rectifier. For example, the DC-DC converter may convert the voltage of the DC power rectified by the rectifier into approximately 24.9 V. In the above-described embodiment, the station device 200 is described as including a rectifier 271 and a DC-DC converter 272, but is not limited thereto, and the station device 200 may include a transformer (AC-AC converter) and a rectifier.

The charging terminal may be in contact with the charging terminal of the robot 100 and may be exposed externally to contact a first charging terminal of the robot 100. The charging terminal may apply a DC voltage output from the DC-DC converter to the charging terminal of the robot 100.

In addition, the charging unit 210 may further include a field effective transistor (FET), and when a charging condition is satisfied, the FET may be turned on to supply power to the robot 100 via the charging terminal.

The Hall sensor 220 is configured to detect that the robot 100 has been docked. In particular, the Hall sensor 220 may detect the docking of the robot 100 by detecting the magnetic field generated by the electromagnet 140 of the robot 100.

The communication interface 230 may communicate with an external device. Since the description of the communication interface 230 is identical to the function of the communication interface 130, a duplicate description thereof will be omitted.

In particular, the communication interface 230 may perform the communication connection with the communication interface 130 of the robot 100 while the robot 100 returns to the station device 200. The communication interface 230 may transmit the information about the docking status to the robot 100 under the control of the processor 260. The processor 260 may include two or more processors. The processor 260 may include one or more of CPU, APU, MIC, DSP, NPU, a hardware accelerator, FPGA, ASIC, or a machine learning accelerator.

The memory 240 may store data for the operation of the station 200 according to various embodiments of the present disclosure.

In addition, the memory 240 may store one or more instructions. In addition, the memory 240 may store programs, applications, and data for driving the station device 200.

The switch 250 is a component for detecting the docking of the robot 100. When the switch 250 is turned on, the station device 200 may control the communication interface 230 to transmit the information about the docking. In this case, the switch 250 may be exposed externally to detect the docking of the robot 100 when the robot 100 is docked with the station device 200.

The processor 260 controls the overall operation of the station device 200. For example, the processor 260 may be connected to components of the station device 200 to control the overall operation of the station device 200. For example, the processor 260 may be connected to the charging unit 210, the Hall sensor 220, the communication interface 230, the memory 240, and the switch 250 to control the station device 200. The processor 260 may be composed of one or more processors. The processor 260 may be composed of one or a plurality of processors.

The processor 260 may perform the operation of the station device 200 according to an embodiment of the present disclosure by executing at least one instruction stored in the memory 240. In some examples, processor 260 may execute the one or more instructions stored in the memory 240 to cause the various components (e.g., charging unit 210, hall sensor 220, communication interface 230, switch 250) of the station device to perform operations described herein.

According to an embodiment of the present disclosure, the processor 260 may control the communication interface 230 to perform the communication connection while the robot 100 returns to the station device 200.

When the robot 100 is docked with the station device 200 and the switch 250 is turned on, the processor 260 may control the communication interface 230 to generate the information about the docking status and transmit the generated information to the robot 100.

When the magnetic field of the electromagnet 140 is detected by the Hall sensor 220, the processor 260 may control the charging unit 210 to charge the robot 100. In some examples, the processor 260 may turn on the FET to charge the robot 100.

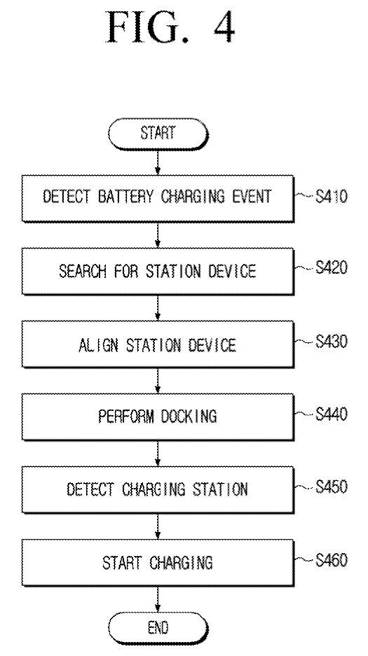

FIG. 4 is a flowchart for explaining a method for charging a battery by a robot docked with a station device according to an embodiment of the present disclosure.

First, the robot 100 may detect a battery charging event (S410). In this case, the battery charging event may be an event in which the battery charge of state of the robot 100 falls below a threshold (i.e., an event in which the output voltage approaches a minimum voltage), an event in which a user command is input to return to the station device 200, or the robot 100.

The robot 100 may search for the station device 200 (S420). In some examples, the robot 100 may identify the location of the station device 200 using a map generated through a simultaneous localization and mapping (SLAM) method and may search for the information about the station device 200 using various sensors. In this case, the information of the station device 200 may include shape information of the station device 200, reflection pattern information of the station device 20, QR code information, etc. In some examples, the robot 100 may acquire shape information, QR code information, etc., of the station device 200 using an image sensor, and may acquire reflection pattern information using a LiDAR sensor, etc. Furthermore, the robot 100 may travel to return to the station device 200.

The robot 100 may align with the station device 200 (S430). For example, the robot 100 may measure the distance between the robot 100 and the station device 200 using various sensors, etc., and may align with the station device 200 using the sensing information acquired through the LiDAR sensor, the image sensor, etc.

The robot 100 may perform the docking (S440). In this case, the docking refers to an operation in which two objects adjust their speed and other conditions to approach and meet each other, and the two objects that have met may be physically connected.

The robot 100 may detect the station device 200 (S450). For example, when the communication connection (or pairing) is performed by the communication interface 130 (particularly, a Bluetooth module) while the robot 100 is docked with the station device 200, and then the switch 250 is turned on when the robot 100 is docked with the station device 200, the robot 100 may receive the information about whether it is docked from the station device 200. Accordingly, the robot 100 may detect the charging station 200 based on the information about whether or not it is docked.

The robot 100 may start the charging (S460). For example, the robot 100 may apply a current to the electromagnet 140 based on the detection of the charging station 200. When the Hall sensor 220 of the station device 200 detects the magnetic field generated by the electromagnet to which the current is applied, the station device 200 may turn on the FET of the charging unit 210. The robot 100 may start charging using power supplied from the charging unit 210.

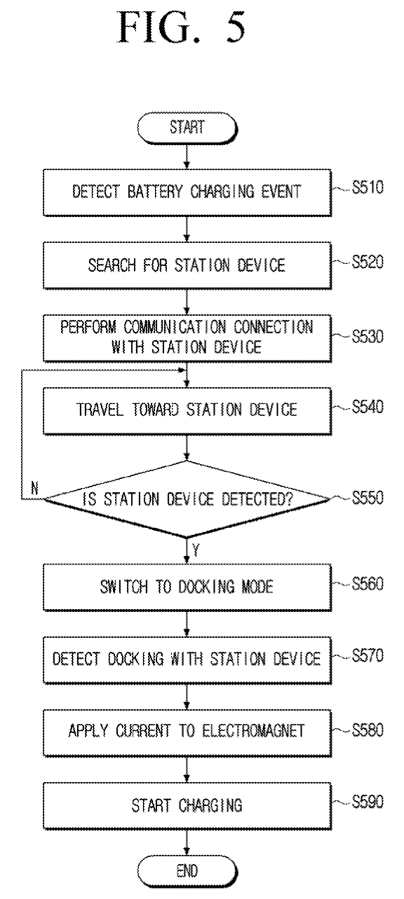

FIG. 5 is a flowchart illustrating a specific method for charging a battery of a robot through the station device according to an embodiment of the present disclosure.

First, the robot 100 may detect a battery charging event (S510). In this case, the battery charging event may be an event in which the battery charge of state of the robot 100 falls below a threshold (i.e., an event in which the output voltage approaches a minimum voltage), an event in which a user command is input to return to the station device 200, or the robot 100.

The robot 100 may search for the station device 200 (S520). In some examples, the robot 100 may identify the location of the station device 200 using a map generated through a simultaneous localization and mapping (SLAM) method and may search for the information about the station device 200 using various sensors. In this case, the information of the station device 200 may include shape information of the station device 200, reflection pattern information of the station device 20, QR code information, etc. In some examples, the robot 100 may acquire shape information, QR code information, etc., of the station device 200 using an image sensor, and may acquire reflection pattern information using a LiDAR sensor, etc.

The robot 100 may perform the communication connection with the station device 200 (S530). In this case, the robot 100 may perform the communication connection with the station device 200 using the Bluetooth module. In this case, the robot 100 may transmit a signal including identification information of the robot 100, and when the station device 200 receives a response to the signal, perform the communication connection.

The robot 100 may travel to the station device 200 (S540). In some examples, the robot 100 may travel to the station device 200 using a pre-stored map. In this case, the robot 100 operates in a normal traveling mode and may travel at a first speed until it detects the station device 200.

The robot 100 may determine whether the station device 200 has been detected (S550). The robot 100 may detect the station device 200 via an image sensor. For example, the robot 100 may recognize the station device 200 by detecting its features in an image captured by the image sensor, and may calculate the location and posture of the robot 100 for docking to align the robot 100 and the station device 200.

When the station device 200 is detected (550-Y), the robot 100 may switch to the docking mode (S560). When switching to docking mode, the robot 100 may attempt to dock with the station device 200 at a second speed lower than the first speed of the normal traveling mode.

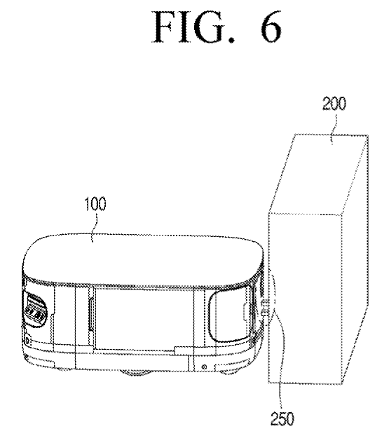

The robot 100 may detect docking with the station device 200 (S570). For example, as illustrated in FIG. 6, when the robot 100 is docked with the station device 200, the switch 250 of the station device 200 may be pressed and turned on. The station device 200 may transmit information about whether or not the robot 100 is docked by turning on the switch 250. In this case, the information about whether or not the robot is docked may include the identification information of the station device 200, the docking success information, etc. The robot 100 may receive the information about whether or not the robot is docked and detect docking with the station device 200.

The robot 100 may apply a current to the electromagnet 140 (S580). For example, the robot 100 may generate a magnetic field by applying a current to the electromagnet 140. Accordingly, the station device 200 may detect a magnetic field using the Hall sensor 220 to identify (or confirm) the docking of the robot 100.

The robot 100 may start the charging (S590). For example, when the station device 200 detects the docking of the robot 100 using the Hall sensor, the station device 200 may turn on the FET to supply power to the robot 100. The robot 100 may start charging by supplying power.

When the charging of the robot 100 is complete, the electronic apparatus 100 may deactivate the electromagnet 140 without supplying a current.

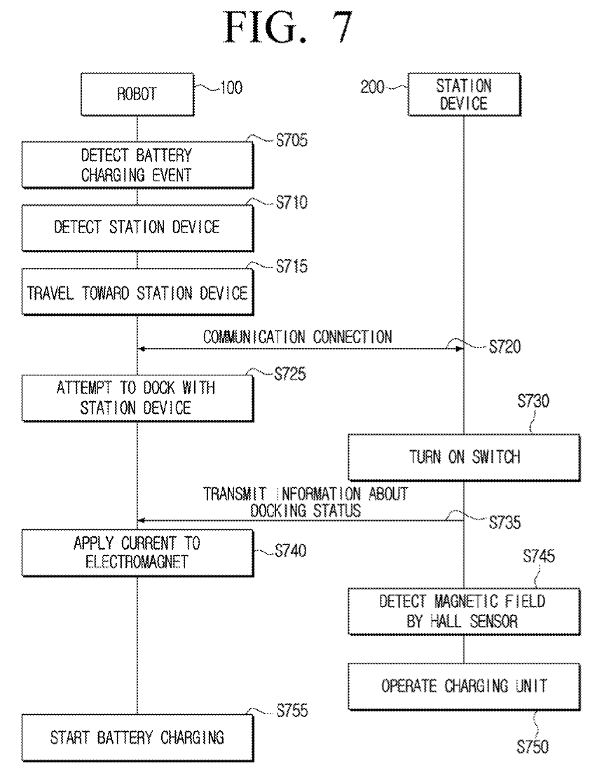

FIG. 7 is a flowchart for describing a method for controlling a robot charging system according to an embodiment of the present disclosure.

The robot 100 may detect the battery charging event (S705). In this case, the battery charging event may be an event in which the battery charge of state of the robot 100 falls below a threshold (i.e., an event in which the output voltage approaches a minimum voltage), an event in which a user command is input to return to the station device 200, or the robot 100.

The robot 100 may detect the station device 200 (S710). For example, the robot 100 may identify the location of the station device 200 using the pre-stored map and detect the station device 200 using various sensors.

The robot 100 may travel to the station device 200 (S715). For example, the robot 100 may travel to the station device 200 using the pre-stored map.

While the robot 100 travels to the station device 200, the robot 100 and the station device 200 may perform the communication connection (S720).

The robot 100 may attempt to dock with the station device 200 (S725). For example, the robot 100 may align with the station device 200, switch to docking mode, and attempt to dock with the station device 200.

The station device 200 may detect that the switch 250 is turned on (S730). In some examples, when the robot 100 contacts the station device 200 while attempting to dock with the station device 200, the station device 200 may detect that the switch 250 located at the contact location of the robot 100 is turned on.

The station device 200 may transmit the information about the docking status to the robot 100 (S735). In some examples, the station device 200 may transmit the information about the docking status to the robot 100 based on the switch being turned on.

The robot 100 may apply a current to the electromagnet 140 based on the information about the docking status (S740). Accordingly, the electromagnet 140 of the robot 100 may generate a magnetic field.

The station device 200 may detect the magnetic field using the Hall sensor 220 (S745). In some examples, the station device 200 may identify that the robot 100 has completed docking with the station device 200.

The station device 200 may operate the charging unit 210 (S750). In some examples, the station device 200 may supply power to the robot 100 by turning on the FET of the charging unit 210.

The robot 100 may start charging the battery 150 (S755). In some examples, the robot 100 may start the charging based on the power supplied from the station device 200. When the charging is completed, the robot 100 may stop applying a current to the electromagnet 100. By applying a current to the electromagnet 140 during the charging, the robot 100 may be more firmly secured to the station device 200 via the electromagnet 140.

As described above, by supplying a current to the electromagnet 140 when the robot 100 is docked with the station device 200, the phenomenon of metallic foreign matter sticking to the magnet during the normal traveling mode may be prevented, thereby preventing safety accidents.

In the above-described embodiment, when the robot 100 is docked with the station device 200, the function of supplying a current to the electromagnet 140 to prevent safety accidents has been described. However, this is merely an example, and the electromagnet 140 provided in the robot 100 may perform various functions.

In an embodiment, the robot 100 may transmit various pieces of information by turning the current supplied to the electromagnet 140 on and off. In some examples, when the robot 100 is docked with the station device 200, by turning the current supplied to the electromagnet 140 on and off, the information about the robot 100, the communication information between the robot 100 and the station device 200, the emergency situation information, etc., may be transmitted. For example, when the robot 100 is docked with the station device 200, by turning on/off the current supplied to the electromagnet 140, the robot 100 may provide the station device 200 with the current status information (e.g., battery information, etc.) of the robot 100 and the communication information (e.g., information confirming that the communication connection is complete, etc.) between the robot 100 and the station device 200. In addition, when the robot 100 is docked with the station device 200 but the communication connection between the robot 100 and the station device 200 is disconnected (e.g., a Bluetooth communication connection is disconnected, etc.), the robot 100 may provide the station device 200 with the emergency situation information (e.g., information that an overcurrent is supplied to the robot 100, etc.) by turning on/off the current supplied to the electromagnet 140.

According to an embodiment of the disclosure, various embodiments described above may be implemented by software including instructions stored in a machine-readable storage medium (for example, a computer-readable storage medium). A machine is a device capable of calling a stored instruction from a storage medium and operating according to the called instruction, and may include the electronic apparatus of the disclosed embodiments. In the case in which a command is executed by the processor, the processor may directly perform a function corresponding to the command or other components may perform the function corresponding to the command under a control of the processor. The command may include codes created or executed by a compiler or an interpreter. The machine-readable storage medium may be provided in a form of a non-transitory storage medium. Here, the term “non-transitory” means that the storage medium is tangible without including a signal, and does not distinguish whether data are semi-permanently or temporarily stored in the storage medium.

In addition, according to an embodiment of the disclosure, the above-described methods according to the diverse embodiments may be included and provided in a computer program product. The computer program product may be traded as a product between a seller and a purchaser. The computer program product may be distributed in a form of a storage medium (for example, a compact disc read only memory (CD-ROM)) that may be read by the machine or online through an application store (for example, PlayStore^{TM}). In case of the online distribution, at least a portion of the computer program product may be at least temporarily stored in a storage medium such as a memory of a server of a manufacturer, a server of an application store, or a relay server or be temporarily generated.

In addition, according to an embodiment of the disclosure, various embodiments described above may be implemented in a computer or a computer-readable recording medium using software, hardware, or a combination of software and hardware. In some cases, embodiments described in the present disclosure may be implemented by the processor itself. According to a software implementation, embodiments such as procedures and functions described in the disclosure may be implemented by separate software. Each software may perform one or more functions and operations described in the disclosure.

Computer instructions for performing processing operations of the machines according to the diverse embodiment of the disclosure described above may be stored in a non-transitory computer-readable medium. The computer instructions stored in the non-transitory computer-readable medium allow a specific machine to perform the processing operations in the machine according to the diverse embodiments described above when they are executed by a processor of the specific machine. The non-transitory computer-readable medium is not a medium that stores data for a while, such as a register, a cache, a memory, or the like, but means a medium that semi-permanently stores data and is readable by the apparatus. A specific example of the non-transitory computer-readable medium may include a compact disk (CD), a digital versatile disk (DVD), a hard disk, a Blu-ray disk, a universal serial bus (USB), a memory card, a read only memory (ROM), or the like.

In addition, each of components (for example, modules or programs) according to various embodiments described above may include a single entity or a plurality of entities, and some of the corresponding sub-components described above may be omitted or other sub-components may be further included in the diverse embodiments. Alternatively or additionally, some components (e.g., modules or programs) may be integrated into one entity and perform the same or similar functions performed by each corresponding component prior to integration. Operations performed by the modules, the programs, or the other components according to the diverse embodiments may be executed in a sequential manner, a parallel manner, an iterative manner, or a heuristic manner, at least some of the operations may be performed in a different order or be omitted, or other operations may be added.

Although embodiments of the disclosure have been illustrated and described hereinabove, the disclosure is not limited to the abovementioned specific embodiments, but may be variously modified by those skilled in the art to which the disclosure pertains without departing from the gist of the disclosure as disclosed in the accompanying claims. These modifications should also be understood to fall within the scope and spirit of the disclosure.

What is claimed is:

1. A robot, comprising:
a communication interface configured to communicate with an external device;
an electromagnet configured to generate a magnetic field in a Hall sensor included in a station device;
a battery;
memory storing instructions; and
one or more processors connected to the communication interface, the electromagnet, the battery, and the memory,
wherein the instructions, when executed by the one or more processors individually or collectively, cause the robot to:
control the communication interface to communicate with the station device based on an event for charging the battery;
receive information about a docking status from the station device through the communication interface based on the robot being docked with the station device;
apply current to the electromagnet to generate the magnetic field based on the information about the docking status; and
charge the battery by receiving power from the station device based on the magnetic field being detected by the Hall sensor.

2. The robot of claim 1, wherein the event for charging the battery includes at least one of:
an event in which remaining battery of the robot falls below a threshold;
an event in which a user command for returning to the station device is input; or
an event in which the robot completes an operation corresponding to the user command.

3. The robot of claim 1, wherein instructions, when executed by the one or more processors individually or collectively, further cause the robot to:
when the event for charging the battery occurs, return to the station device based on a map stored in the memory, and
control the communication interface to communicate with the station device while returning to the station device.

4. The robot of claim 1, further comprising:
an image sensor,
wherein the instructions, when executed by the one or more processors individually or collectively, further cause the robot to:
when the station device is recognized based on an image acquired through the image sensor, switch a mode of the robot from a normal traveling mode to a docking mode such that the robot is to be docked with the station device.

5. The robot of claim 1, wherein the station device comprises a switch, and
wherein the instructions, when executed by the one or more processors individually or collectively, further cause the robot to:
based on the robot being docked with the station device, turn on the switch and receive information about the docking status from the station device through the communication interface.

6. The robot of claim 5, wherein instructions, when executed by the one or more processors individually or collectively, further cause the robot to:
based on the robot receiving the information about the docking status through the communication interface, the switch being turned on, and a magnetic field being detected by the Hall sensor, apply a charging current to the battery of the robot.

7. The robot of claim 1, wherein the electromagnet is at a location corresponding to the Hall sensor of the station device based on the robot being docked with the station device.

8. A method for controlling a robot, comprising:
communicate with a station device based on an event for charging a battery;
receiving information about a docking status from the station device based on the robot being docked with the station device;
applying a current to an electromagnet included in the robot to generate a magnetic field based on the information about the docking status; and
charging the battery by being supplied power from the station device based on the magnetic field being detected by a Hall sensor.

9. The method of claim 8, wherein the event for charging the battery is at least one of:
an event in which remaining battery of the robot falls below a threshold;
an event in which a user command for returning to the station device is input; and
an event in which the robot completes an operation based on the user command.

10. The method of claim 8, wherein, when the event for charging the battery occurs during the communication with the station device, the robot returns to the station device based on a map stored in the memory, and communicates with the station device while returning to the station device.

11. The method of claim 8, wherein the receiving of the information comprises switching a mode of the robot from a normal traveling mode to a docking mode so that the robot is docked with the station device, when the station device is recognized based on an image acquired through an image sensor of the robot.

12. The method of claim 8, wherein the station device includes a switch, and
when the robot is docked with the station device during receipt of the information, the switch is turned on to receive the information about the docking status through a communication interface.

13. The method of claim 12, wherein, when the robot receives the information about the docking status through the communication interface:
the switch is turned on;
a magnetic field is detected by the Hall sensor; and
a charging current is applied to the battery of the robot.

14. The method of claim 8, wherein the electromagnet is at a location corresponding to the Hall sensor of the station device based on the robot being docked with the station device.

15. A method for controlling a robot charging system including a station device and a robot, comprising:
establishing a connection between the robot and the station device while the robot is traveling toward the station device based on an event for charging a battery;
turning on a switch included in the station device to transmit information about a docking status to the robot, based on the robot being docked with the station device;
applying, by the robot, a current to an electromagnet included in the robot to generate a magnetic field based on the information about the docking status;
supplying power based on the magnetic field being detected by a Hall sensor included in the station device; and
charging, by the robot, the battery of the robot using the power supplied to the robot.
